(19) United States
(12) Patent Application Publication
(10) Pub. No.: US 2006/0085345 A1
(43) Pub. Date: Apr. 20, 2006

(54) Right to receive data

(76) Inventors: Rajesh B. Khandelwal, Bridgewater, NJ (US); David A. Braun, Denville, NJ (US); Il-Pyung Park, Princeton Junction, NJ (US); Yue Ma, West Windsor, NJ (US); Stephen L. Johnson, Erdenheim, PA (US); Luyang Li, South Plainfield, NJ (US)

Correspondence Address: HARNESS, DICKEY & PIERCE, P.L.C., P.O. BOX 828, BLOOMFIELD HILLS, MI, 48303, US

(21) Appl. No.: 10/968,766

(22) Filed: Oct. 19, 2004

(51) Int. Cl. G06Q 99/00

(52) U.S. Cl. 705/51

(57) ABSTRACT

A computer-implemented method is presented that allows a user to receive a work such as a movie at any time and at any location. A first client connects to a server through a network. A work is selected through the first client. Transaction data related to a user's right to receive a work is created and stored. A request is sent to the server to transmit the work. The work is transmitted to either the first or the second clients at any time based upon the user's right to receive the work.

### FIELD OF THE INVENTION

The present invention generally relates to distribution of data over a network, and more specifically to purchasing a right to receive digital or analog content.

### BACKGROUND OF THE INVENTION

Increasingly, consumers choose to view programs through a video on demand (VOD) service provided by a cable company or satellite multiple service/systems operator (“MSO”). Typically, a consumer has twenty-four hours in which to view a program that he or she has selected. After this time period, the program is no longer available to the user.

Some users may be unable to view the program within twenty-four hours. If a user still desires to view the program after exceeding this time period, he must reorder the program. He is then required to pay for the program a second time.

Another limitation relates to the automatic transmission of data to the same terminal or device that requested the program. This is problematic for users who travel.

These limitations are also not beneficial to distributors of cable services. For example, some users may forgo selecting a program through the VOD service because of the limited time or location in which to view the program. It is therefore desirable to have a method or system that addresses the disadvantages associated with present cable services that transfer data to a terminal or device.

### BRIEF DESCRIPTION OF THE DRAWINGS

The invention will become more fully understood from the detailed description and the accompanying drawings, wherein:

FIG. 1 is a block diagram of a network system in accordance with one embodiment of the invention;

FIG. 2A is a block diagram of a peer-to-peer system in accordance with one embodiment of the invention;

FIG. 2B is a block diagram of a peer-to-peer system in accordance with one embodiment of the invention;

FIG. 3A is a block diagram of a client/server system in accordance with one embodiment of the invention;

FIG. 3B is a block diagram of a client/server system in accordance with one embodiment of the invention;

FIG. 4 is a block diagram illustrating an analog cable network for transferring a work from a distributor to a receiving device in accordance with one embodiment of the invention;

FIG. 5 is a block diagram illustrating a digital cable network for transferring a work from a distributor to a receiving device in accordance with one embodiment of the invention;

FIG. 6 is a schematic diagram of a receiving device in accordance with one embodiment of the invention; and

FIG. 7 is a flow diagram of one method of purchasing and downloading a product in accordance with one embodiment of the invention.

### DETAILED DESCRIPTION

Generally, the present invention involves a user selecting or purchasing a right to receive a work (e.g., a movie, etc.) from a distributor. The right to receive a work allows a user to view, play, present, or use the work. The user may receive a work at a time or a location of the user's choosing. For example, a user may select and/or purchase a right to receive a work through his home computer in New Jersey; however, he may elect to receive the work a month later while staying in a hotel in New York, N.Y.

To better understand aspects of the invention, a distributor and a work are defined. A distributor is a person, entity, or business that provides, sells, or leases a right to receive a work. A work is data (i.e., analog or digital data). The work may include an audiovisual work (e.g., movies, computer games, etc.), an audio work (e.g., sound recording etc.), a visual work (e.g., picture, etc.) or a computer program. While a work is generally protected by copyright law, the scope of the definition of a work may include data that may not be protected by copyright law.

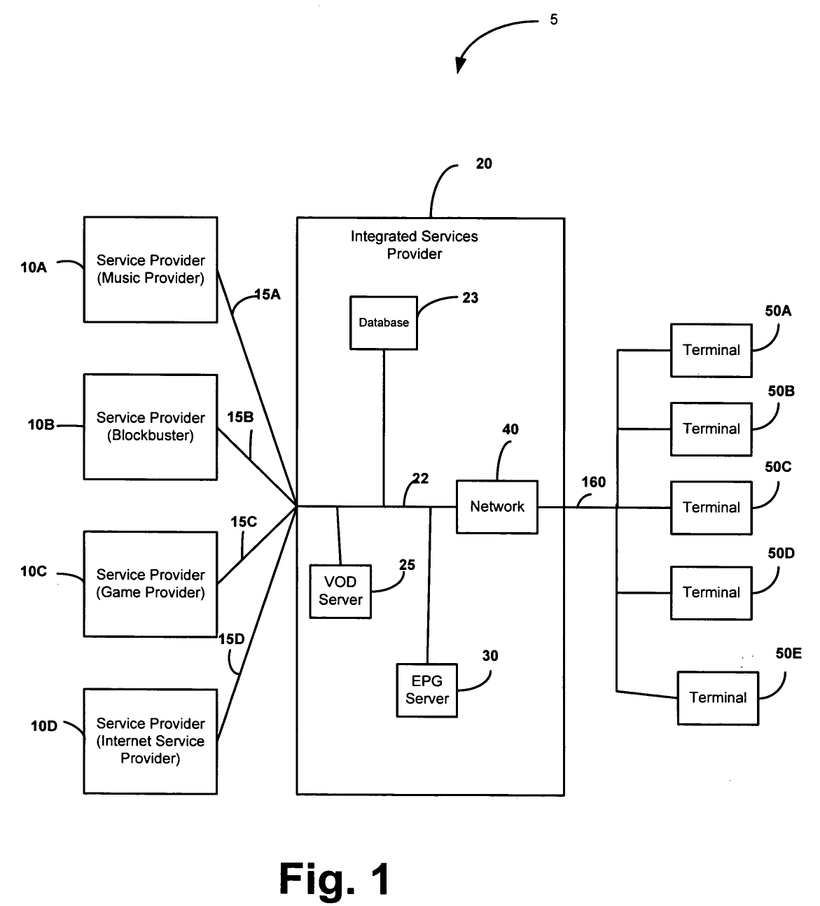

FIG. 1 is a block diagram of a system 5 that is used to select and/or to purchase a right to receive a work from a distributor. The system 5 includes service providers (SP) 10A-10D, integrated service provider (ISP) 20, and a plurality of terminals 50A-50E. The SP 10A-10D or the ISP 20 are distributors of a work. The SP 10A-10D create, license, or sell works to the ISP 20. The SP 10A-10D are configured to transfer audio, visual, or audiovisual content of a work over communication links 15A-15D to the ISP 20. For example, BLOCKBUSTER VIDEO 10B provides DVDs or videos whereas the game provider 10C provides games that are able to be distributed by the network 40. The SP 10A-10D also may include music providers (e.g., Sony, BMG, etc.), television program providers (e.g., cable companies, etc.), Internet service providers (e.g., America Online, MSN, etc.), satellite companies, or other like businesses, entities, or parties.

The ISP 20 unifies the SP 10A-10D. The ISP 20 creates, owns, sells or licenses at least one copy of a work to a user or an intelligent agent acting on behalf of the user. The ISP 20 includes a VOD server 25, an electronic programming guide (EPG) server 30, a database 23, and a network 40.

The VOD server 25 and the EPG server 30, coupled to the network 40 through the communication link 22, perform a variety of controlling operations. For example, the EPG server 30 transfers data onto the communication link 22 to the network 40 to allow a list of works such as an EPG to be presented on a graphical user interface (GUI) of one of the terminals 50A-50E.

The network 40 such as a head-end is configured to receive, store, or transfer data (e.g., a work, a key, etc.) over a communication link 160 to the terminals 50A-50E. A head-end is the facility at a local cable TV business that originates and communicates cable TV services and cable modem services to users of the terminals 50A-50E.

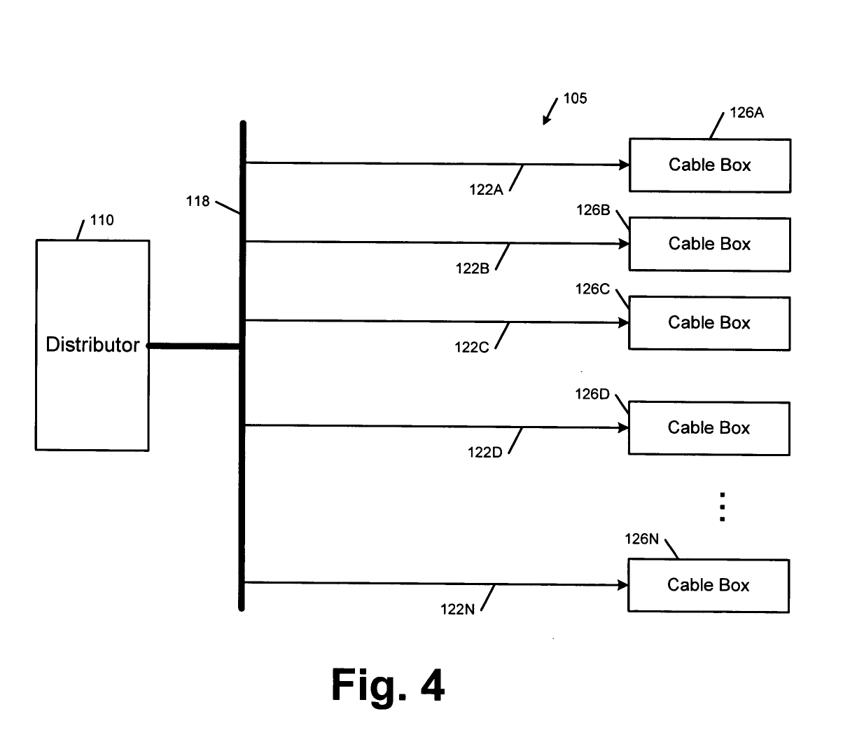

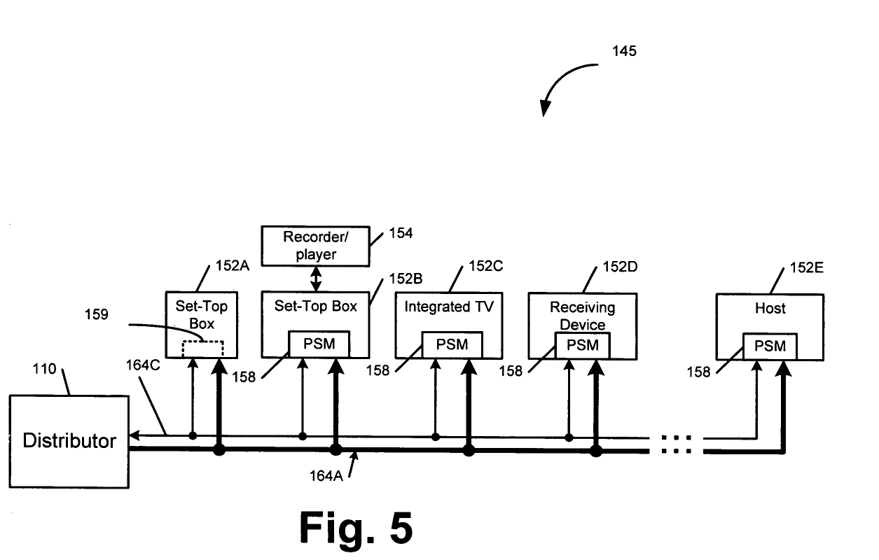

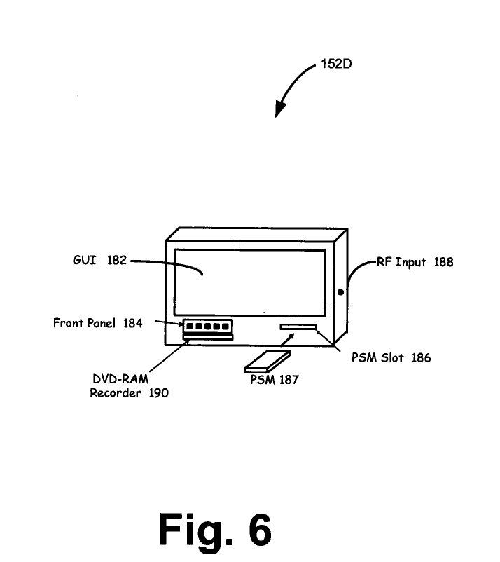

The network 40 may also poll terminals 50A-50E for data. Polling for data is a form of requesting or checking for information from the terminals 50A-50E. For example, the network 40 may poll a terminal 50A-50E to determine whether a key is available so that the terminal 50A-50E may receive a work. The network 40 may be an analog cable network 105 illustrated in FIG. 4, a digital cable network 145 illustrated in FIG. 5 a wide area network (WAN), the Internet, a terrestrial broadcast system (i.e. a broadcast signal over the air), or a satellite system (i.e. signals from a satellite). The cable network 105 in FIG. 4 includes a distributor 110 that generates cable signals over cable 118. The cable drops 122A, 122B, 122C, 122D . . . , and 122N provide the cable signals to cable boxes 126A, 126B, 126C, 126D . . . , and 126N at customer locations. In addition to providing analog cable services, digital services including data (e.g., work, key, etc.) may also be transferred over the cable network 145 as shown in FIG. 5 by using, for example, a cable standard such as the OpenCable™ standard. OpenCable™ is a standard that has been defined by cable operators to provide a common platform for digital cable-ready devices. A typical terminal or receiving device 152D for receiving a work, shown in FIG. 6, may include a recorder 190 that stores data on a storage medium. The storage medium includes fixed, networked (e.g., email, etc.), or a removable storage mediums. Examples of a removable storage medium include a DVD, a CD, a memory card, a Smart card, a Secure Digital (SD) card and a CableCARD

In one embodiment, the storage medium stores a key (e.g., a cookie, a token, etc.) from network 40 that indicates the user has a right to receive a work. The receiving device 152D also includes a GUI 182, a front panel 184, a pluggable security module (PSM) slot 186 configured to receive a PSM 187 and a radio frequency (RF) input 188.

The PSM 158 and 187 shown in FIGS. 5 and 6 provide security and authentication of the user, and/or the terminal 50A-50E. Additionally, session keys may be exchanged between the distributor 110 and the PSM 158 and 187 before the work is transmitted, thereby protecting the work from being intercepted during transmission.

Referring to FIG. 5, the PSM 158 communicates data to the distributor 110 using an out-of-band (OOB) channel 164C over the cable 164A to the distributor 110. Alternatively, the PSM 158 passes data to the devices such as the STB 152B, the integrated TV 152C, the receiving device 152D, or the host 152E. The security component 159, embedded into the STB 152A, also performs security and user authentication. The STBs 152A and 152B, the integrated TV 152C, the host 152E, and the recorder/player 154 are briefly described.

The STB 152A and 152B are commonly used to receive and decode digital television broadcasts. The STB 152A and 152B also interface with a network such as the Internet. The STB 152B may receive and unscramble incoming television signals or perform complex functions such as videoconferencing, home networking, IP telephony, VOD, high-speed Internet TV services or other like services.

Generally, a STB 152A, 152B consists of a platform that includes a central processing unit (CPU), memory, on-screen display (OSD) circuitry, a tuner, a PSM interface, and a secure decoder. The secure decoder typically includes a decryption engine for decrypting data, a MPEG decoder to process digital video content, and a buffer memory that temporarily stores data.

The PSM 158 and the security decoder exchange session keys prior to decoding a work. Through the use of the session key, the PSM 158 is able to provide the key(s) necessary for the security decoder to decode the work. The security decoder uses content keys (e.g., a subscriber key, a PSM session key, a content session key, a security decoder (Sdec) session key, a title key, etc.) to decrypt the work prior to decoding the work. The tuner is configured to receive analog and/or digital data in data packets from the distributor 110. The tuner also passes data in data packets from the distributor 1 10 to the PSM 158.

The integrated TV 152C includes a STB (not shown). In comparison, the host 152E is either a STB, an integrated television, or a receiving device configured to store and to execute a digital TV (DTV) middleware platform such as the OpenCable™ Application Platform implementation.

The recorder/player 154, coupled to the STB 1 52B, is configured to record and to play (or present) the work to a user. In another embodiment, the recorder/player 154 is configured to store data such as a key.

Given this description of the components of the system 5, the techniques of the present invention are now presented. In one embodiment, a list of works such as an EPG is displayed on a graphical user interface (GUI) of a terminal 50A-50E. The user of the terminal 50A-50E enters into a transaction by selecting and/or purchasing a right to receive a work from the ISP 20. A transaction is an act between at least two entities or parties. Transaction data is generated at the network 40 and is typically stored in the database 23.

A key (e.g., cookie, token, etc.) is generated and is optionally encrypted by the network 40. The key is sent from the network 40 over the communication link 160 to one of the terminals 50A-50E. The key is stored at the terminal 50A-50E. The key may then be accessed from the terminal 50A-50E and stored on another storage medium such as a portable storage medium. In another embodiment, the key is emailed from the network 40 to a user or to a person designated to receive the key by the user.

The user then chooses to receive a work at any time or place by transmitting the key over the communication link 160 to the network 40 from one of the terminals 50A-50E. For example, the user may choose to receive the work three weeks after selecting and/or purchasing the right to receive work. Additionally, the user may choose to receive the work at a location different from where he selected and/or purchased the right to receive the work. For example, while the user may have selected and/or purchased the right to receive the work on the Internet using his home computer located in New Jersey, he may elect to receive the work through a cable network or across MSO cable network boundaries via a television in his hotel room while vacationing in New York, N.Y.

After receiving the key, the network 40 optionally verifies that the key is valid. For example, the network 40 accesses data that links the selection and/or purchase of a right to receive a work to an account that is associated with a user, a terminal, an entity, and/or a business. The network 40 then compares this data with the key. Thereafter, the VOD server 25 ensures that the work (e.g., movie, television show, etc.) is transferred via the network 40 over a communication link 160 to one of the terminals 50A-50E.

In another embodiment, the present invention controls whether copies may be made in order of a key to receive a work. For example, if the POD includes a slot for a SD Card, then copying of the key (e.g., cookie, token, etc.) can be controlled or prevented. In this embodiment, only the head-end and the POD have the key to access the secure area of the SD card. If the work (e.g. movie) is downloaded to a local removable medium, then the right to receive the cookie can be used to enable the remote POD to decrypt the content from the local removable medium. This is accomplished by providing a media key in the cookie itself. Alternatively, the cookie is sent to the head-end to acquire the media key. If the cookie is portable, the cookie is typically stored on the removable media either in a secure area similar to the secure area in an SD card or in a non-secure area.

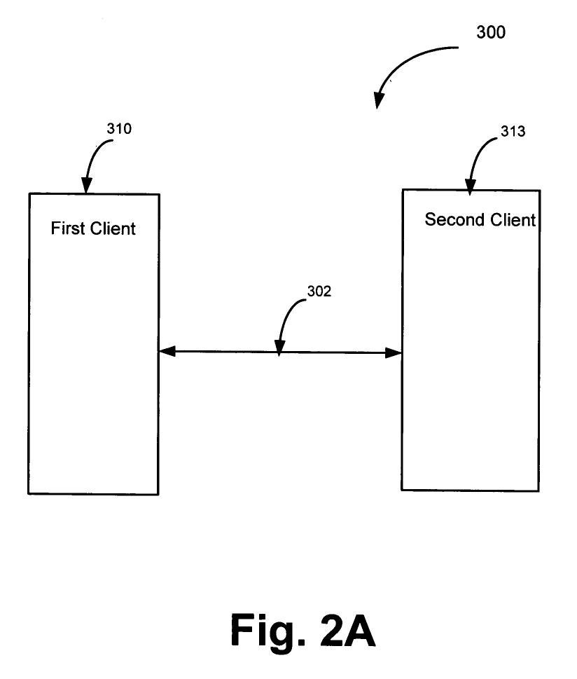

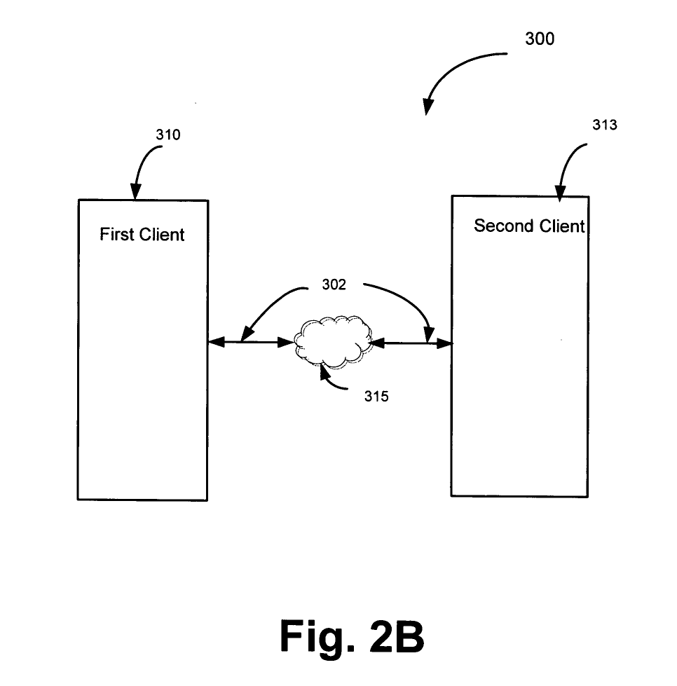

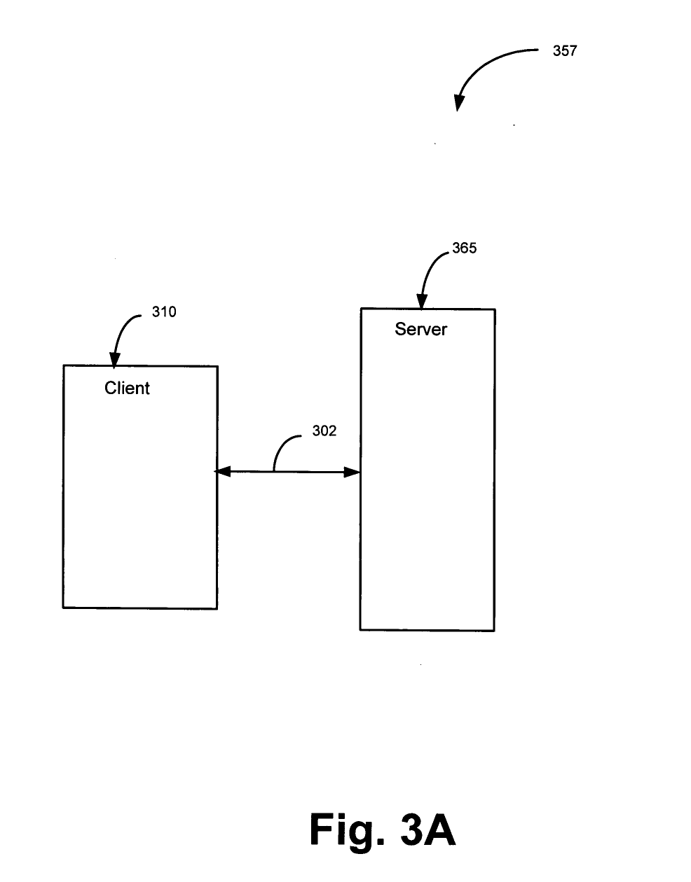

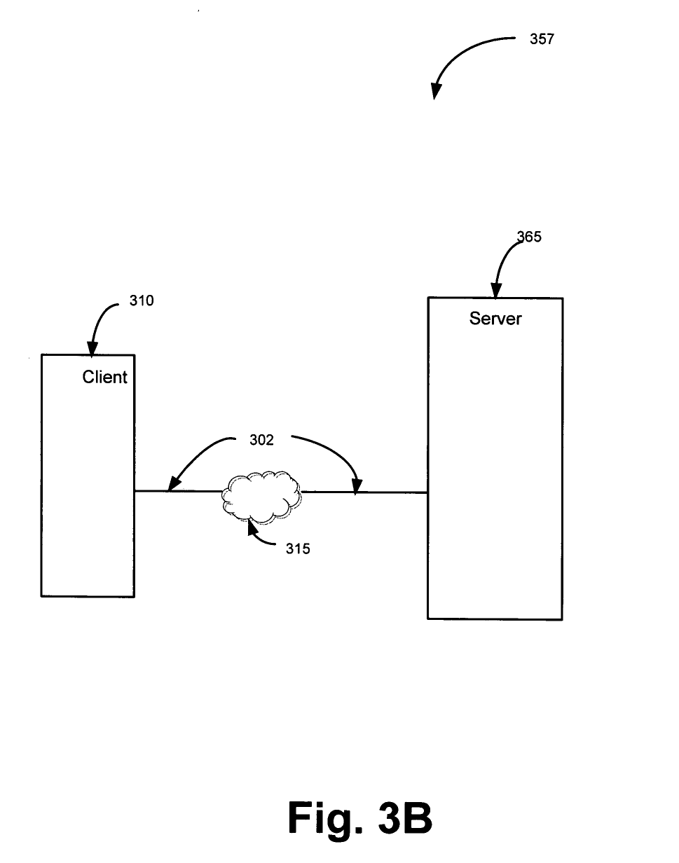

In addition to the system 5 illustrated in FIG. 1, techniques of the invention may be implemented through various other networks, such as a peer-to-peer network (FIGS. 2A-2B) and a client/server network (FIGS. 3A-3B). The peer-to-peer network such as the system 300, represented in FIGS. 2A-2B, includes a first client 310, a communication link 302, and a second client 313. The first and second clients 310, 313 possess similar or the same capabilities. For example, the first and the second clients 310, 313 are computers (e.g., laptop computer, a personal digital assistant, a cellular phone, or other like device) or a playing device (e.g., a recording device, a legacy device such as Walkman, etc.) that are able to perform either wireless (e.g., Bluetooth, Ethernet, WIFI, etc.) or wired communication to connect with the communication link 302. Additionally, skilled artisans appreciate that either the first or the second clients 310, 313 may represent a virtual public kiosk, which is not typically associated with a user. FIG. 2B is also a peer-to-peer network except the first and second client 313 connects through the network 315. The network 315 may be the Internet or a wide area network. In this embodiment, either the first or the second client 310, 313 initiates a session with the other client.

In system 300, a first client 310 sends a message to the second client. The message includes a list of available works or a single work. This list is displayed on the GUI of the second client 313. The user of the second client selects and/or purchases a right to receive a work through the GUI and transmits this request to the first client 310. The first client 310 generates and transmits a key to the second client 313 from the first client 310. The second client 313 stores the key in memory (not shown). The user of the second client 313 transmits this key to the first client when the user wishes to receive the work. The user may use the second client 313 or another client to receive the work.

FIGS. 3A-3B represent a client/server network 357 that transmits a work to a client 310 once a user's right to receive a work is verified. FIG. 3A illustrates one embodiment in which the client 310 connects with the server 365. In an alternate embodiment, FIG. 3B illustrates the same client/server network 357 as FIG. 3A except the client 310 and the server 365 connect through the network 315.

In one embodiment, a list of works or a single work is presented through the GUI of the client 310. The user through the GUI of client 310 selects and/or purchases a right to receive a work. A message is sent from the client 310 to the server 365 regarding the selection of the work. Transaction data related to the user's selection of the work is generated and stored on the server 365 or in a database associated with the server 365.

A key (e.g., a cookie, token, etc.) is then generated and transmitted from the server 365 to the client 310. The key is stored in the memory of a client (e.g., a set-top box). This key can then be stored onto a portable memory device (e.g., SD card, etc.). In one embodiment, the key is e-mailed to the user. The key is accessed and transmitted to the server 365 by a client controlled by a user. The key is optionally authenticated by the server 365. The server 365 transmits the work over a network to the client 310.

The server 365 ensures that the work is only being played on the user's clients or, at most, one client not owned by the user. Conventional security measures may be implemented to protect the key. For example, the key can be password protected. Alternatively, a user's biometric data (e.g., fingerprint, iris scan, etc.) may be required to obtain access to the key.

The key is typically invalidated at the server 365,on the first use of the cookie. This invalidates only the key from use on another client.

In another embodiment, a user may be granted the right to receive a work k times. To ensure that the user can access the work only k times, a first key (e.g., cookie, etc.) is invalidated after one use. A second key is then generated and transmitted to the user. The second key allows k-1 accesses to a work. This embodiment is exemplified by a user that is granted the right to receive a work on five separate occasions. The first key is deleted after its use. The second key is generated thereby granting the user the right to receive a work on four separate occasions. This type of operation continues until his right to receive the work is exhausted.

After some discrete time period has passed, the user decides he wishes to receive the work. A discrete time period is defined as the time in which a distributor (e.g., SP10A-10D or ISP 20 of FIG. 1) is able to transmit, for example, a movie without using the present invention (e.g., greater than twenty-four hours). The user's client 310 connects with the server 365 and requests that the work be transmitted over communication link 160. The user and/or the client 310 are optionally authenticated using conventional techniques (e.g., password, input of biometric data, etc.). The server 365 then optionally uses conventional techniques to access the transaction data and determine that the user has a right to receive the work. The work is then sent from the server 365 over the communication link 302 to the client 310.

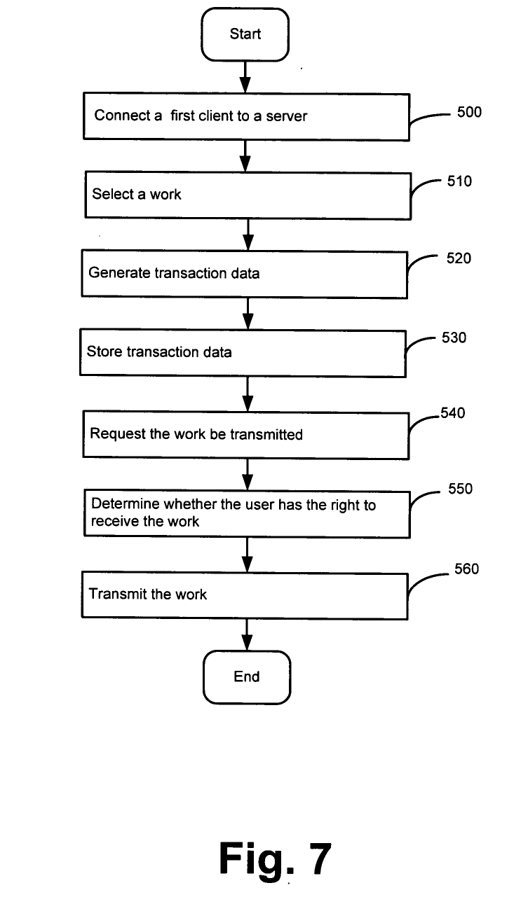

FIG. 7 is a flow diagram of one method to select and/or purchase a right to receive a work. A first client connects to a server at operation 500. A message to select and/or purchase a right to receive a work is sent from the first client to the server at operation 510. The right to receive the work may be selected and/or purchased at a public location (e.g. kiosk, supermarket, etc.). The work may also be selected and/or purchased over the Internet, the cable network, or other suitable network. Transaction data is generated based upon the work selected by the first client at operation 520. The transaction data indicates that the user of the first client has the right to receive the work. The transaction data is stored on the server or in a database associated with the server at operation 530. A key is generated and sent from the server to the terminal at operation 535. The key allows the user to receive the work at a time and a location of the user's choosing. The key is sent to the server to transmit the work. The work is transmitted either to the first client or a second client at operation 540.

Receiving the work at the second client shows the portability feature of the right to receive the work. Examples of the portability feature include transmitting (e.g., email) the right to receive the work to a third person, presenting the right to receive the work as a gift to a third person, and/or using the right to receive the work at a device that was not initially used to request the work (e.g., terminal at a hotel, etc.). The transaction data is then accessed at the server to determine whether the user has the right to receive the work at operation 550. The work is transmitted to either the first or the second clients at any time beyond a discrete time period (e.g. twenty-four hours) and based solely upon the right to receive the work at operation 560. The mode of receiving the work may be different from the mode of selecting or purchasing the work. For instance, the user may have purchased a right to receive the work over a cable network but he elects to receive the work over the Internet.

It will be appreciated that more or fewer processes may be incorporated into the methods described herein without departing from the scope of the invention and that no particular order is implied by the arrangement of blocks shown and described herein. Skilled artisans will appreciate that the methods described herein may be embodied in machine-executable instructions (e.g., software). The instructions can be used to cause a general-purpose or special-purpose processor that is programmed with the instructions to perform the operations described. Alternatively, the operations may be performed by specific hardware components that contain hard-wired logic for performing the operations, or by any combination of programmed computer components and custom hardware components. The methods may be provided as a computer program product that may include a machine-readable medium having stored thereon instructions that may be used to program a computer (or other electronic devices) to perform the methods. For the purposes of this specification, the term “machine-readable medium” includes any medium that is capable of storing or encoding a sequence of instructions for execution by the machine and that cause the machine to perform any one of the methodologies of the invention. The term “machine-readable medium” includes, but is not be limited to, solid-state memories, optical and magnetic disks, and carrier wave signals. Furthermore, it is common in the art to speak of software, in one form or another (e.g., program, procedure, process, application, module, logic, etc.), as taking an action or causing a result. Such expressions are merely a shorthand way of saying that the execution of the software by a computer causes the processor of the computer to perform an action or a produce a result.

Further areas of applicability of the invention will become apparent from the detailed description provided above. It should be understood that the detailed description and specific examples, while indicating the preferred embodiment of the invention, are intended for purposes of illustration only and are not intended to limit the scope of the invention.

1. A computer-implemented method comprising:
connecting a server and a first client;
sending a message for selecting a work from the first client to the server;
generating transaction data based upon the work selected by the first client, the transaction data associates a right to receive the work with an account of a customer;
storing the transaction data;
sending a request to the server to transmit the work from one of the first client and a second client;
accessing the transaction data at the server to determine whether the user has the right to receive the work; and
transmitting the work to one of the first and the second clients at any time beyond a discrete time period and based solely upon the right to receive the work.

2. The computer implemented method of claim 1 wherein the discrete time period is twenty four hours.

3. The computer-implemented method of claim 1 wherein the work is presented through a video-on-demand service.

4. The computer-implemented method of claim 1 wherein the second client is operated by one of a person and a third party.

5. The computer-implemented method of claim 1 wherein the communication mode for transmitting the work is different from a communication mode used to send the message to select the work.

6. The computer implemented method of claim 5 wherein sending the message for selecting a work occurs through a communication mode comprising a cable network, a terrestrial, a satellite network, a wide area network, and an Internet.

7. The computer-implemented method of claim 1 wherein the user is an operator of the second client and the user lacks ownership control over the second client.

8. A computer-implemented method comprising:
connecting a server to a first client over a network;
sending a message for selecting a work from the first client to the server;
generating transaction data based upon the work selected by the first client, the transaction data indicates that a user of the first client has the right to receive the work;
transmitting a key from the server to the first client;
storing a copy of the key onto a portable storage medium;
sending a request and a copy of the key to the server to transmit the work to one of the first client and a second client;
determining through the copy of the key that a person has the right to receive the work; and
transmitting the work to one of the first and the second clients at any time beyond twenty four hours based solely upon the right to receive the work.

9. The computer-implemented method of claim 8 wherein the key includes a media key.

10. The computer-implemented method of claim 8 wherein the key is invalidated at the server after the key is initially used to access the work.

11. The computer-implemented method of claim 8 wherein the key is transmitted to the server to obtain a media key.

12. A computer-implemented peer-to-peer system comprising:
connecting a first client to a second client over a network;
sending a message for selecting a work from the second client to the first client;
generating transaction data based upon the work selected by the second client, the transaction data indicates that the user of the second client has the right to receive the work;
transmitting a key from the first client to the second client;
storing a copy of the key onto a portable storage medium;
sending a request and the copy of the key to the first client to transmit the work to one of the second client and a third client;
determining through the copy of the key that the user has the right to receive the work; and
transmitting the work to one of the second client and the third client at any time based solely upon the right to receive the work.

13. The computer-implemented method of claim 12 wherein the key includes a media key.

14. The computer-implemented method of claim 12 wherein the key is invalidated at the first client after the key is initially used to access the work.

15. The computer-implemented method of claim 12 wherein the key is transmitted to the first client to obtain a media key.

16. A computer-implemented method comprising:
connecting a head-end to a first client;
sending a message for selecting a work from the first client to the head-end;
generating transaction data based upon the work selected by the first client, the transaction data indicates that the user of the first client has the right to receive the work;
transmitting a key from the head-end to the first client;
storing a copy of the first key onto a portable storage medium;
sending a request and a copy of the first key to the head-end to transmit the work to one of the first client and a second client;
determining through the copy of the first key that the user has the right to receive the work; and
transmitting the work to one of the first and the second clients at any time based solely upon the right to receive the work.

17. The computer-implemented method of claim 16 wherein the first key includes a media key.

18. The computer-implemented method of claim 16 wherein the first key is invalidated at the head-end after the first key is initially used to access the work.

19. The computer-implemented method of claim 16 wherein the first key is transmitted to the head-end to obtain a media key.

20. The computer-implemented method of claim 16 wherein the first key is invalidated after use.

21. The computer-implemented method of claim 16 wherein a second key is generated and transmitted to one of the first and the second clients, the second key replaces the first key.

22. The computer-implemented method of claim 21 wherein the second key possesses a lower maximum number of times to access a work than the first key.

23. The computer-implemented method of claim 22 wherein the second key has a maximum number of times which is one less than a maximum number of times a first key can access a work.

24. The computer-implemented method of claim 16 wherein the first key is password protected.

25. The computer-implemented method of claim 16 wherein the first key requires a user's biometric data to be accessed.
